(19) United States
(12) Patent Application Publication
(10) Pub. No.: US 2026/0051568 A1
(43) Pub. Date: Feb. 19, 2026

(54) IMMERSION COOLED BATTERY ARRAY DESIGNS FOR PROVIDING ENHANCED TRACTION BATTERY THERMAL MANAGEMENT

(71) Applicant: FORD GLOBAL TECHNOLOGIES, LLC, Dearborn, MI (US)

(72) Inventor: Xiaogang ZHANG, Novi, MI (US)

(21) Appl. No.: 18/802,204

(22) Filed: Aug. 13, 2024

(51) Int. Cl. H01M 10/6568; H01M 10/613; H01M 10/625; H01M 50/249; H01M 50/291

(52) U.S. Cl. CPC H01M 10/6568; H01M 10/613; H01M 10/625; H01M 50/249; H01M 50/291

(57) ABSTRACT

Immersion cooling systems are provided for managing thermal energy levels of traction battery packs. A battery array of the traction battery pack may be configured to establish a multi-stream cooling fluid flow path. A cooling fluid (e.g., a dielectric fluid) may be communicated through the multi-stream cooling fluid flow path for immersion cooling battery cells of the battery array. During a battery thermal event originating from one or more upstream battery cells of the battery array, the multi-stream cooling fluid flow path may be configured to isolate hot gases and thereby prevent the hot gases from thermally influencing downstream battery cells of the battery array.

### TECHNICAL FIELD

This disclosure relates generally to electrified vehicle traction battery packs, and more particularly to immersion cooling systems capable of managing thermal energy levels within traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, an array housing that provides an interior volume, an installation plate arranged within the interior volume, a first battery cell packet and a second battery cell packet positioned on the installation plate, and a middle plate arranged between the first battery cell packet and the second battery cell packet. A first slot of the installation plate is located upstream from the middle plate, and a second slot of the installation plate is located downstream from the middle plate.

In a further non-limiting embodiment of the foregoing battery array, the installation plate is arranged to subdivide the interior volume between a first interior volume section and a second interior volume section.

In a further non-limiting embodiment of either of the foregoing battery arrays, the first interior volume section extends between a bottom plate of the array housing and the installation plate, and the second interior volume section extends between the installation plate and a top plate of the array housing.

In a further non-limiting embodiment of any of the foregoing battery arrays, an intake runner is fluidly connected to both the first interior volume section and the second interior volume section, and an exhaust runner fluidly is connected to the second interior volume section.

In a further non-limiting embodiment of any of the foregoing battery arrays, the first slot and the second slot are formed through the installation plate.

In a further non-limiting embodiment of any of the foregoing battery arrays, the first slot is fluidly connected to a first flow path that extends between the middle plate and the first battery cell packet, and the second slot is fluidly connected to a second flow path that extends between the middle plate and the second battery cell packet.

In a further non-limiting embodiment of any of the foregoing battery arrays, the middle plate extends vertically from the installation plate toward a top plate of the array housing.

In a further non-limiting embodiment of any of the foregoing battery arrays, an upper edge portion of the middle plate terminates prior to reaching the top plate.

In a further non-limiting embodiment of any of the foregoing battery arrays, the upper edge portion includes a rearward tilt surface.

In a further non-limiting embodiment of any of the foregoing battery arrays, the rearward tilt surface is flat.

In a further non-limiting embodiment of any of the foregoing battery arrays, the rearward tilt surface is curved or rounded.

A battery array for a traction battery pack according to another exemplary aspect of the present disclosure includes, among other things, an array housing providing an interior volume that extends between a top plate and a bottom plate, an installation plate arranged to subdivide the interior volume into a first interior volume section and a second interior volume section, a middle plate arranged to subdivide the second interior volume section into an upstream section and a downstream section, a first battery cell packet positioned within the upstream section, a second battery cell packet positioned within the downstream section, an intake runner fluidly connected to both the first interior volume section and the second interior volume section and configured to receive a cooling fluid for immersion cooling the first battery cell packet and the second battery cell packet, and an exhaust runner fluidly connected to the second interior volume section and configured to expel the cooling fluid from the interior volume.

In a further non-limiting embodiment of the foregoing battery array, the first interior volume section extends between the bottom plate and the installation plate, and the second interior volume section extends between the installation plate and the top plate.

In a further non-limiting embodiment of either of the foregoing battery arrays, the first interior volume section is configured to receive a first portion of the cooling fluid, and the second interior volume section is configured to receive a second portion of the cooling fluid.

In a further non-limiting embodiment of any of the foregoing battery arrays, a first slot is formed in the installation plate and is configured to direct a first flow stream of the first portion of the cooling fluid into the upstream section of the second interior volume section.

In a further non-limiting embodiment of any of the foregoing battery arrays, a second slot is formed in the installation plate and is configured to direct a second flow stream of the first portion of the cooling fluid into the downstream section of the second interior volume section.

In a further non-limiting embodiment of any of the foregoing battery arrays, the first slot is located upstream from the middle plate, and the second slot is located downstream from the middle plate.

In a further non-limiting embodiment of any of the foregoing battery arrays, the first flow stream is configured to redirect a mixture of the second portion of the cooling fluid and a battery vent byproduct released from within the first battery cell packet during a battery thermal event.

In a further non-limiting embodiment of any of the foregoing battery arrays, an upper edge portion of the middle plate includes a rearward tilt surface.

In a further non-limiting embodiment of any of the foregoing battery arrays, the rearward tilt surface is flat or curved.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 schematically illustrates a traction battery pack equipped with an immersion cooling system.

FIG. 3 illustrates an exemplary battery array of the traction battery pack of FIG. 2.

FIG. 4 is a cross-sectional view through section 4-4 of FIG. 3.

FIG. 5 illustrates select portions of the battery array of FIG. 3.

FIG. 6 illustrates an upper edge portion of an exemplary middle plate of a battery array.

FIG. 7 illustrates an upper edge portion of another exemplary middle plate of a battery array.

### DETAILED DESCRIPTION

This disclosure details immersion cooling systems for managing thermal energy levels of traction battery packs. A battery array of the traction battery pack may be configured to establish a multi-stream cooling fluid flow path. A cooling fluid (e.g., a dielectric fluid) may be communicated through the multi-stream cooling fluid flow path for immersion cooling battery cells of the battery array. During a battery thermal event originating from one or more upstream battery cells of the battery array, the multi-stream cooling fluid flow path may be configured to isolate hot gases and thereby prevent the hot gases from thermally influencing downstream battery cells of the battery array. These and other features are discussed in greater detail in the following paragraphs of this detailed description.

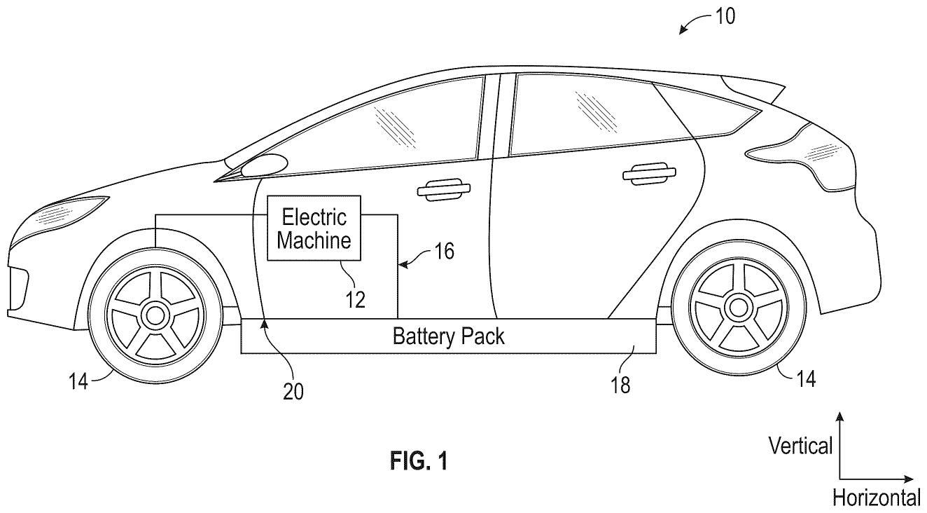

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

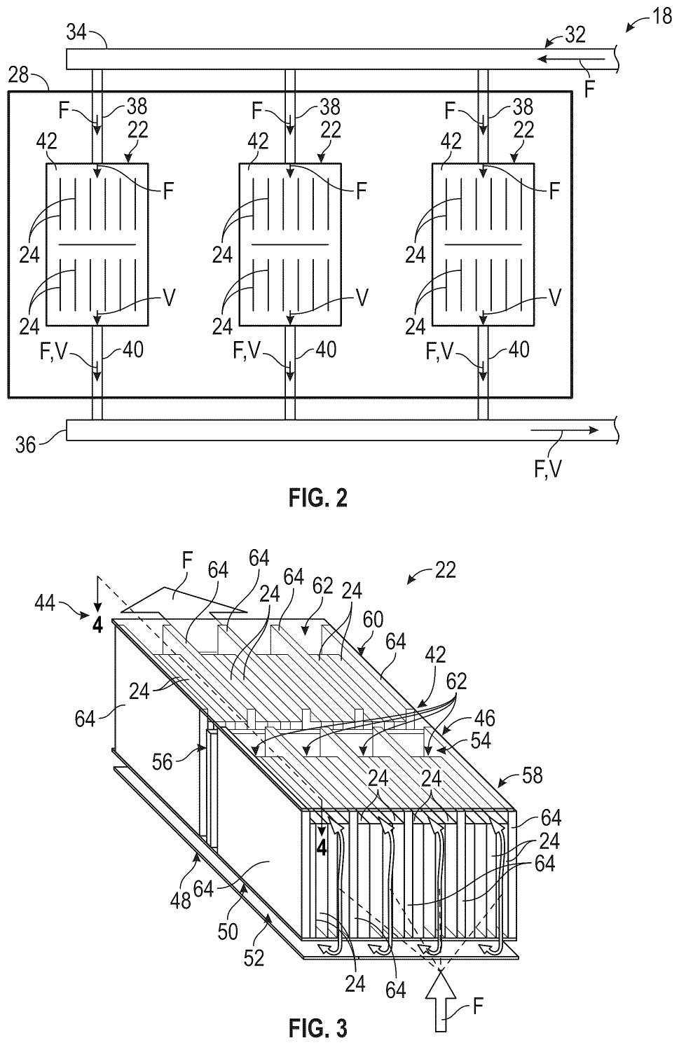

FIG. 2 illustrates additional details associated with the traction battery pack 18 of the electrified vehicle 10 of FIG. 1. The traction battery pack 18 may include a plurality of battery arrays 22 (e.g., battery modules or groupings of rechargeable battery cells 24) capable of outputting electrical power to power the electric machine 12 and/or other electrical loads of the electrified vehicle 10 for supporting electric propulsion. Each battery array 22 may include a plurality of battery cells 24. The total number of battery arrays 22 and battery cells 24 provided within the traction battery pack 18 is not intended to limit this disclosure.

In an embodiment, the battery cells 24 of each battery array 22 are lithium-ion pouch cells. However, battery cells having other geometries (prismatic, cylindrical, etc.), other chemistries (nickel-metal hydride, lead-acid, etc.), or both could alternatively be utilized within the scope of this disclosure.

The battery arrays 22 may be arranged in on or more rows and/or tiers inside the traction battery pack 18. In an embodiment, the traction battery pack 18 includes three battery arrays 22, and each battery array 22 may include a plurality of battery cells 24 sub-grouped into two or more battery cell packets. However, other configurations are possible, and therefore the traction battery pack 18 could include a greater or fewer number of battery arrays and battery cells within the scope of this disclosure.

The battery arrays 22 and various other battery internal components (e.g., bussed electrical center, battery electric control module, wiring, connectors, etc.) may be housed inside of an enclosure assembly 28 of the traction battery pack 18. Although shown schematically, the enclosure assembly 28 could embody a single-piece design or a multi-piece design (e.g., enclosure cover and enclosure tray that are joined together to establish an interior for housing the battery arrays 22). The size, shape, and overall configuration of the enclosure assembly 28 are not intended to limit this disclosure. In an embodiment, the enclosure assembly 28 provides a sealed enclosure around the battery arrays 22 and other battery internal components of the traction battery pack 18. The enclosure assembly 28 provides the outermost surfaces of the traction battery pack 18.

Each battery array 22 may be compartmentalized and is therefore fluidly isolated from the other battery arrays 22 of the traction battery pack 18. Accordingly, gases, effluent particles, and/or other vent byproducts V that could be vented by one or more of the battery cells 24 of one or more of the battery arrays 22, such as during a battery thermal event, cannot flow directly to another of the battery arrays 22 of the traction battery pack 18.

Each battery array 22 may be spaced apart from the other battery arrays 22 of the traction battery pack 18. For example, the battery arrays 22 may be separated from one another by their respective housings. Although not specifically shown, an insulation shield could be disposed between the respective housings of adjacent battery arrays 22 for blocking the transfer of thermal energy from one battery array 22 to another.

The traction battery pack 18 may additionally include an immersion cooling system 32. The immersion cooling system 32 may provide a closed loop flow circuit for thermally managing the battery arrays 22 of the traction battery pack 18. For example, the immersion cooling system 32 may be configured for introducing a cooling fluid F inside each battery array 22 for directly contacting individual surfaces of the battery cells 24 with the cooling fluid F. In an embodiment, the cooling fluid F is a dielectric fluid. However, other cooling fluids could be utilized within the scope of this disclosure.

The immersion cooling system 32 may include an intake manifold 34, an exhaust manifold 36, a plurality of intake runners 38, and a plurality of exhaust runners 40. The intake manifold 34 and the exhaust manifold 36 may each extend at least partially outside the enclosure assembly 28 of the traction battery pack 18, and at least a portion of the intake runners 38 and the exhaust runners 40 may extend into the interior of the enclosure assembly 28. The intake runners 38 may be fluidly connected to the intake manifold 34, and the exhaust runners 40 may be fluidly connected to the exhaust manifold 36. Each intake runner 38 and each exhaust runner 40 may further be fluidly connected to an interior volume 42 of one of the battery arrays 22.

The cooling fluid F may be selectively communicated from a reservoir (not shown) through the intake manifold 34 before being separated into the multiple intake runners 38. The cooling fluid F may then separately enter the interior volume 42 of each battery array 22 through the intake runners 38. The cooling fluid F may pick up heat from the battery cells 24 through convective heat transfer as it flows through the interior volume 42 of each battery array 22, thereby carrying away excessive heat and stabilizing the temperatures of the battery cells 24.

The cooling fluid F may exit each battery array 22 through the exhaust runners 40 before merging again within the exhaust manifold 36. The cooling fluid F may then be returned to the reservoir. Although not specifically shown in the highly schematic depiction of FIG. 2, the closed loop flow circuit of the immersion cooling system 32 could additionally include features such as a pump, flow control valves, sensors, controllers, etc.

One or more of the battery cells 24 packaged within the traction battery pack 18 can periodically release vent byproducts V, such as during an overcharge condition, an overdischarging condition, a short circuit, etc. The vent byproducts V can be released from the battery cells 24 through a vent port. Pressure increases within one of the battery cells 24 can cause the vent port to rupture, thereby creating a path for the vent byproducts V to be released from inside the battery cell 24.

The released vent byproducts V can be expelled from the traction battery pack 18 through the exhaust runners 40 and the exhaust manifold 36. The vent byproducts V can therefore travel along a vent flow path that is combined with the coolant flow path of the cooling fluid F. As further discussed below, the cooling fluid F can intermix with the vent byproducts V during thermal events to thermally manage the heat associated with the vent byproducts V during the thermal event.

FIGS. 3, 4, and 5 illustrate an exemplary design of a battery array 22 of the traction battery pack 18 of FIGS. 1 and 2. Each battery array 22 of the traction battery pack 18 may include an identical design to the battery array 22 shown in FIG. 3, or a similar design as its electrical connections with neighboring battery arrays can vary in order to completely a necessary electrical circuit of the traction battery pack 18.

The battery array 22 includes a plurality of battery cells 24 housed within an array housing 44. The array housing 44 may be configured as a six-sided box-like structure that includes a top plate 46, a bottom plate 48, a pair of side plates (not shown for simplicity and clarity), and a pair of end plates (not shown for simplicity and clarity). The top plate 46, the bottom plate 48, the side plates, and the end plates may be connected together to establish the interior volume 42 of the battery array 22. The battery cells 24 may be positioned in two or more groupings within the interior volume 42.

An installation plate 50 may be arranged within the interior volume 42 at a location between one of the substituent plates of the array housing 44 and the battery cells 24. In an embodiment, the installation plate 50 is positioned vertically above the bottom plate 48 of the array housing 44. However, other arrangements could be possible and are thus contemplated within the scope of this disclosure. The installation plate 50 could be integrated as part of the array housing 44 or could be a completely separate structure from the array housing 44.

The installation plate 50 may subdivide the interior volume 42 into a first interior volume section 52 and a second interior volume section 54. The first interior volume section 52 may extend between the bottom plate 48 and the installation plate 50, and the second interior volume section 54 may extend between installation plate 50 and the top plate 46. In an embodiment, the second interior volume section 54 includes a larger volume compared to the first interior volume section 52.

A middle plate 56 may be arranged within the second interior volume section 54. In an embodiment, the middle plate 56 is positioned to extend vertically from the installation plate 50 in a direction toward the top plate 46. The middle plate 56 may be mounted to the installation plate 50 and may terminate prior to reaching the top plate 46. However, other arrangements could be possible and are thus contemplated within the scope of this disclosure. The middle plate 56 could be integrated as part of the array housing 44 or could be a completely separate structure from the array housing 44.

The middle plate 56 may be arranged to subdivide the second interior volume section 54 of the interior volume 42 into an upstream section 58 and a downstream section 60. The upstream section 58 may extend between the intake runner 38 and the middle plate 56, and the downstream section 60 may extend between the middle plate 56 and the exhaust runner 40.

The battery cells 24 may be arranged into multiple cell packets 62 in both the upstream section 58 and the downstream section 60 of the second interior volume section 54. The cell packets 62 may be positioned on (here, atop) the installation plate 50. Each cell packet 62 can include multiple battery cells 24 stacked between a pair of insulation shields 64. The cell packets 62 positioned within the upstream section 58 provide upstream cell packets of the battery array 22, and the cell packets 62 positioned within the downstream section 60 provide downstream cell packets of the battery array 22. The downstream cell packets 62 are downstream relative to the upstream cell packets 62 with respect to the direction of flow of the cooling fluid F and can thus receive the cooling fluid F in series relative to the upstream cell packets 62. The upstream cell packets 62 of the battery array 22 can receive the cooling fluid F in parallel with one another.

The insulation shields 64 may be configured to block the transfer of thermal energy from one cell packet 62 to another. The insulation shields 64 may further provide a desired level of compressibility for more easily positioning the cell packets 62 within the array housing 44. Each insulation shield 64 may be made of mica, aerogels, or any other suitable material or combinations of materials.

The battery cells 24 of each cell packet 62 may be arranged such that major sides of the cells extend in parallel with the side plates of the array housing 44, and minor sides of the cells extend in parallel with the end plates of the array housing. However, other arrangements are contemplated within the scope of this disclosure.

A first slot 66 and a second slot 68 may be formed through the installation plate 50 for fluidly coupling the first interior volume section 52 and the second interior volume section 54 of the interior volume 42. The first slot 66 and the second slot 68 may allow the cooling fluid F to flow vertically upward from the first interior volume section 52 into the second interior volume section 54 for contributing to the immersion cooling of the battery cells 24. The first slot 66 may located on an upstream side of the middle plate 56 at a location axially between the upstream cell packets 62 and the middle plate 56, and the second slot 68 may be located on a downstream side of the middle plate 56 at a location axially between the middle plate 56 and the downstream cell packets 62.

The intake runner 38 of the battery array 22 may be fluidly connected to both the first interior volume section 52 and the second interior volume section 54 of the interior volume 42, and the exhaust runner 40 may be fluidly connected to the second interior volume section 54 of the interior volume 42. The cooling fluid F may therefore enter the interior volume 42 near a bottom of the battery array 22 and flow into both the first interior volume section 52 and the second interior volume section 54, and the cooling fluid F may exit the interior volume 42 from the second interior volume section 54 near a top of the battery array 22.

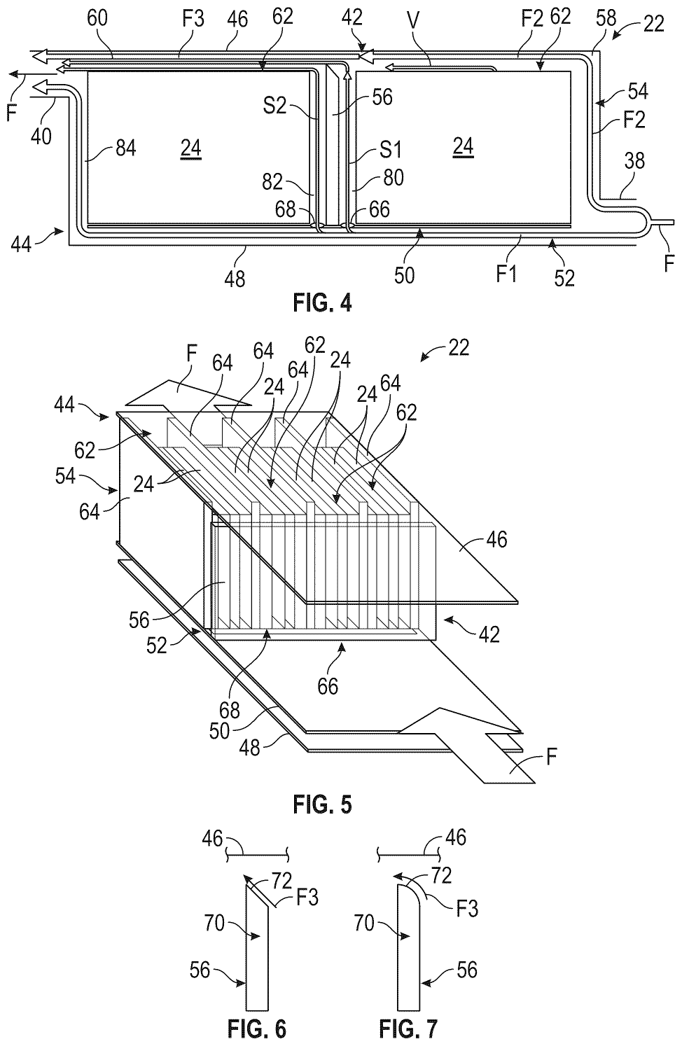

As best illustrated in the cross-sectional view of FIG. 4, the cooling fluid F may enter the battery array 22 through the intake runner 38. A first portion F1 of the cooling fluid F may enter the first interior volume section 52, and a second portion F2 of the cooling fluid F may enter the second interior volume section 54. The first portion F1 of the cooling fluid F may flow laterally (e.g., from right to left in the illustrated embodiment) across the first interior volume section 52, and the second portion F2 of the cooling fluid F may upwardly toward the top plate 46 prior to flowing laterally downstream for thermally managing the upstream cell packets 62 in parallel with one another.

The first portion F1 of the cooling fluid F flowing through the first interior volume section 52 may be split into multiple flow streams by virtue of the first slot 66 and the second slot 68 of the installation plate 50. For example, a first flow stream S1 of the first portion F1 of the cooling fluid F may flow upwardly through the first slot 66 to enter the second interior volume section 54, and a second flow stream S2 of the first portion F1 of the cooling fluid F may flow upwardly through the second slot 68 to enter the second interior volume section 54. From within the second interior volume section 54, the first flow stream S1 may flow upwardly through a first flow passage 80 located between the middle plate 56 and the upstream cell packets 62 for contributing to the thermal management of the battery cells 24 of the upstream cell packets 62, and the second flow stream S2 may flow upwardly through a second flow passage 82 located between the middle plate 56 and the downstream cell packets 62 for contributing to the thermal management of the battery cells 24 of the downstream cell packets 62. The first flow stream S1 and the second flow stream S2 may eventually converge with the second portion F2 of the cooling fluid F near the top of the battery array 22 prior to exiting the interior volume 42 through the exhaust runner 40. Moreover, the first portion F1 of the cooling fluid F flowing through the first interior volume section 52 may eventually flow upwardly through the second interior volume section 54 within a third flow passage 84 located at a downstream location from the downstream cell packets 62 prior to exiting the interior volume 42 through the exhaust runner 40.

By virtue of the above described flow pattern, the cooling fluid F can sweep over and around the major and minor side surfaces of the battery cells 24 for thermally managing the battery cells 24 of the battery array 22 during normal operating conditions of the traction battery pack 18. The above flow pattern may also be beneficial for managing a battery thermal event that can occur inside the battery array 22. For example, one or more of the battery cells 24 of the upstream cell packets 62 could release vent byproducts V directly into the interior volume 42 during the battery thermal event. Once released, the vent byproducts V can intermix with the second portion F2 of the cooling fluid F to provide a mixed fluid F3. The mixed fluid F3 generally has a higher temperature than the second portion F2 of the cooling fluid F. As the mixed fluid F3 flows downstream toward the exhaust runner 40, the first flow stream S1 and the second flow stream S2 can push the mixed fluid F3 in a direction toward the top plate 46, thereby isolating the mixed fluid F3 and substantially preventing it from contacting upper surfaces of the battery cells 24 of the downstream cell packets 62 prior to its exit through the exhaust runner 40. The venting battery cell(s) 24 of the upstream cell packets 62 therefore provides little to no thermal influence on the battery cells 24 of the downstream cell packets 62 during the battery thermal event.

Referring now primarily to FIGS. 6 and 7, an upper edge portion 70 of the middle plate 56 may include features designed to further limit the thermal influence on the battery cells 24 of the downstream cell packets 62 during the battery thermal event. For example, the upper edge portion 70 may include a rearward tilt surface 72 that is configured for redirecting the mixed fluid F3 flowing from the upstream cell packets 62 in a direction toward the top plate 46 of the battery array 22 and away from the upper surfaces of the battery cells 24 of the downstream cell packets 62. The rearward tilt surface 72 may thus augment the isolation of the mixed fluid F provided by first and second flow streams S1, S2.

The rearward tilt surface 72 may be angled in a upstream-to-downstream direction relative to the fluid flow path through the battery array 22. In an embodiment, the rearward tilt surface 72 may be a flat surface (see FIG. 6). In another embodiment, the rearward tilt surface 72 may be a curved or rounded surface (see FIG. 7).

The exemplary traction battery packs of this disclosure include an immersion cooling system for providing enhanced battery cell thermal management. The battery arrays of the traction battery pack may provide a compartmentalized design that maximizes heat transfer from both major and minor side surfaces of the battery cells. Moreover, the unique arrangement and design of slots formed in the installation plate and a middle plate arranged between upstream and downstream cell packets can effectively isolate hot gases originating from upstream battery cells, thereby preventing the hot gases from thermally influencing battery cells located downstream from the venting battery cell(s).

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
an array housing that provides an interior volume;
an installation plate arranged within the interior volume;
a first battery cell packet and a second battery cell packet positioned on the installation plate;
a middle plate arranged between the first battery cell packet and the second battery cell packet;
a first slot of the installation plate located upstream from the middle plate; and
a second slot of the installation plate located downstream from the middle plate.

2. The battery array as recited in claim 1, wherein the installation plate is arranged to subdivide the interior volume between a first interior volume section and a second interior volume section.

3. The battery array as recited in claim 2, wherein the first interior volume section extends between a bottom plate of the array housing and the installation plate, and the second interior volume section extends between the installation plate and a top plate of the array housing.

4. The battery array as recited in claim 3, comprising an intake runner fluidly connected to both the first interior volume section and the second interior volume section, and an exhaust runner fluidly connected to the second interior volume section.

5. The battery array as recited in claim 1, wherein the first slot and the second slot are formed through the installation plate.

6. The battery array as recited in claim 5, wherein the first slot is fluidly connected to a first flow path that extends between the middle plate and the first battery cell packet, and the second slot is fluidly connected to a second flow path that extends between the middle plate and the second battery cell packet.

7. The battery array as recited in claim 1, wherein the middle plate extends vertically from the installation plate toward a top plate of the array housing.

8. The battery array as recited in claim 7, wherein an upper edge portion of the middle plate terminates prior to reaching the top plate.

9. The battery array as recited in claim 8, wherein the upper edge portion includes a rearward tilt surface.

10. The battery array as recited in claim 9, wherein the rearward tilt surface is flat.

11. The battery array as recited in claim 9, wherein the rearward tilt surface is curved or rounded.

12. A battery array for a traction battery pack, comprising:
an array housing providing an interior volume that extends between a top plate and a bottom plate;
an installation plate arranged to subdivide the interior volume into a first interior volume section and a second interior volume section;
a middle plate arranged to subdivide the second interior volume section into an upstream section and a downstream section;
a first battery cell packet positioned within the upstream section;
a second battery cell packet positioned within the downstream section;
an intake runner fluidly connected to both the first interior volume section and the second interior volume section and configured to receive a cooling fluid for immersion cooling the first battery cell packet and the second battery cell packet; and
an exhaust runner fluidly connected to the second interior volume section and configured to expel the cooling fluid from the interior volume.

13. The battery array as recited in claim 12, wherein the first interior volume section extends between the bottom plate and the installation plate, and the second interior volume section extends between the installation plate and the top plate.

14. The battery array as recited in claim 12, wherein the first interior volume section is configured to receive a first portion of the cooling fluid, and the second interior volume section is configured to receive a second portion of the cooling fluid.

15. The battery array as recited in claim 14, comprising a first slot formed in the installation plate and configured to direct a first flow stream of the first portion of the cooling fluid into the upstream section of the second interior volume section.

16. The battery array as recited in claim 15, comprising a second slot formed in the installation plate and configured to direct a second flow stream of the first portion of the cooling fluid into the downstream section of the second interior volume section.

17. The battery array as recited in claim 16, wherein the first slot is located upstream from the middle plate, and the second slot is located downstream from the middle plate.

18. The battery array as recited in claim 15, wherein the first flow stream is configured to redirect a mixture of the second portion of the cooling fluid and a battery vent byproduct released from within the first battery cell packet during a battery thermal event.

19. The battery array as recited in claim 12, wherein an upper edge portion of the middle plate includes a rearward tilt surface.

20. The battery array as recited in claim 19, wherein the rearward tilt surface is flat or curved.
